(19) United States
(12) Patent Application Publication
(10) Pub. No.: US 2008/0100730 A1
(43) Pub. Date: May 1, 2008

(54) IMAGING APPARATUS AND CONTROL METHOD THEREOF

(75) Inventor: Yuji Tsuda, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/927,001

(22) Filed: Oct. 29, 2007

(30) Foreign Application Priority Data
Nov. 1, 2006 (JP) 2006-297342

(51) Int. Cl. H04N 5/225

(52) U.S. Cl. 348/262; 348/E05.024

(57) ABSTRACT

An imaging apparatus includes an imaging unit, a first image generating unit configured to generate a still image having one frame based on two field images obtained by light exposure at the same timing, a second image generating unit configured to generate a still image having one frame based on two field images obtained by light exposure at different timings; and a switching unit configured to switch to either one of the first image generating unit and the second image generating unit, depending on whether a detachably mounted lens apparatus includes a shutter unit that interrupts the exposure of the imaging unit.

### BACKGROUND OF THE INVENTION

1. Field of the Invention

The present invention relates to an imaging apparatus, for example, a digital video camera to which a lens apparatus can be attached, and to a method for controlling such an imaging apparatus.

2. Description of the Related Art

With rapid expansion of digital camera use in recent years, a number of pixels of charge coupled device (CCD) and capacity of memory is increasing, and an image processing technology is improved. Under such circumstances, a need for a video camera product which is capable of capturing both moving images and still images is growing. For example, attention is directed to an interchangeable lens type video camera that can capture not only a high-quality moving image, but also a high-quality still image. For that purpose, a mechanical shutter unit is required which is used in generating a still image (see Japanese Patent Application Laid-open No. 2006-98736).

Use of the mechanical shutter is advantageous in generating a still image as described below. As for CCD, an interlace type CCD is generally used. In a video camera that uses the interlace type CCD, when one screen is one frame, EVEN electric charges and ODD electric charges of scanning lines that constitute one frame, are alternately read. Image signals for one screen are thus generated. However, when time differences between the EVEN electric charges and the ODD electric charges exist, a moving portion of a subject shows a blur so that a high-quality still image is not obtained. Accordingly, while the signals are being read from CCD, CCD is shielded from light by the mechanical shutter. Therefore, the EVEN electric charges and the ODD electric charges captured at the same time are alternately read to generate signals of one screen.

Therefore, a still image having information for one frame can be generated using the mechanical shutter while a high-quality still image of the subject can be obtained without blurs at the moving portion.

If a still image is generated without using the mechanical shutter, the generated still image has information of only one field (i.e., either one of EVEN or ODD electrical charge information) which is only half the required information. Therefore, a quality of the still image deteriorates. For example, when only one field information is used, if there is a sloped line in a picture of the subject, an edge of the sloped line is not smooth. Therefore, resolution is low, and the quality of the still image significantly deteriorates.

As described above, if the mounted interchangeable lens is equipped with the mechanical shutter, a high-quality still image can be captured using the mechanical shutter. However, if the mounted interchangeable lens is not equipped with the mechanical shutter, the user cannot capture a still image. A super-telephoto lens, an ultra wide lens, and a macro lens are already in the market, and the interchangeable lens type video camera has an advantage that these lenses can be attached thereto. However, although such lens having various features can be mounted, there is a problem in that the still image cannot be captured when these lenses having the special features are mounted.

### SUMMARY OF THE INVENTION

The present invention is directed to an imaging apparatus capable of capturing a high-quality still image irrespective of the lens apparatus types, and a control method of the imaging apparatus.

According to an aspect of the present invention, an imaging apparatus includes an imaging unit, a first image generating unit configured to generate a still image having one frame based on two field images obtained by light exposure at the same timing, a second image generating unit configured to generate a still image having one frame based on two field images obtained by light exposure at different timings; and a switching unit configured to switch to either one of the first image generating unit and the second image generating unit, depending on whether a detachably mounted lens apparatus includes a shutter unit that interrupts an exposure of the imaging unit.

According to another aspect of the present invention, a method for controlling the imaging apparatus having an imaging unit includes a first image generating step of generating a still image having one frame based on two field images obtained by light exposure at the same timing, a second image generating step of generating a still image having one frame based on two fields of image obtained by light exposure at different timing, and switching to either one of the first image generating step and the second image generating step, depending on whether a detachably mounted lens apparatus includes a shutter unit that interrupts an exposure of the imaging unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute apart of the specification, illustrate exemplary embodiments, features, and aspects of the invention and, together with the description, serve to explain the principles of the invention.

FIG. 1 is a view illustrating an example configuration of an imaging system according to an exemplary embodiment of the present invention.

FIG. 2 is a view illustrating another example configuration of an imaging system according to an exemplary embodiment of the present invention.

FIG. 3 is a flow chart for describing communication between a camera control unit and a lens control unit illustrated in FIGS. 1 and 2.

FIG. 4 is a flow chart for describing an operation of a camera body illustrated in FIGS. 1 and 2.

FIG. 5 is a flow chart for describing an operation of the camera body illustrated in FIG. 1.

FIG. 6 is a flow chart for describing an operation of an interchangeable lens illustrated in FIG. 1.

FIG. 7 is a flow chart for describing an operation of the interchangeable lens illustrated in FIG. 1.

FIG. 8 is a timing chart for describing an operation of the interchangeable lens and the camera body illustrated in FIG. 1.

FIG. 9 is a diagram for describing a procedure of the camera body illustrated in FIG. 1.

FIG. 10 is a diagram for describing an operation of the camera body illustrated in FIG. 1.

FIG. 11 is a diagram for describing a procedure of the camera body illustrated in FIG. 2.

FIG. 12 is a diagram for describing an operation of the camera body illustrated in FIG. 2.

FIG. 13 is a diagram for describing an operation of the camera body illustrated in FIG. 2.

FIG. 14 is a diagram for describing an operation of the camera body illustrated in FIG. 2.

### DESCRIPTION OF THE EXEMPLARY EMBODIMENTS

Various exemplary embodiments, features, and aspects of the present invention will now herein be described in detail with reference to the drawings. It is to be noted that the relative arrangement of the components, the numerical expressions, and numerical values set forth in these embodiments are not intended to limit the scope of the present invention unless it is specifically stated otherwise.

Now, exemplary embodiments of the present invention will be described below with reference to the attached drawings.

### First Exemplary Embodiment

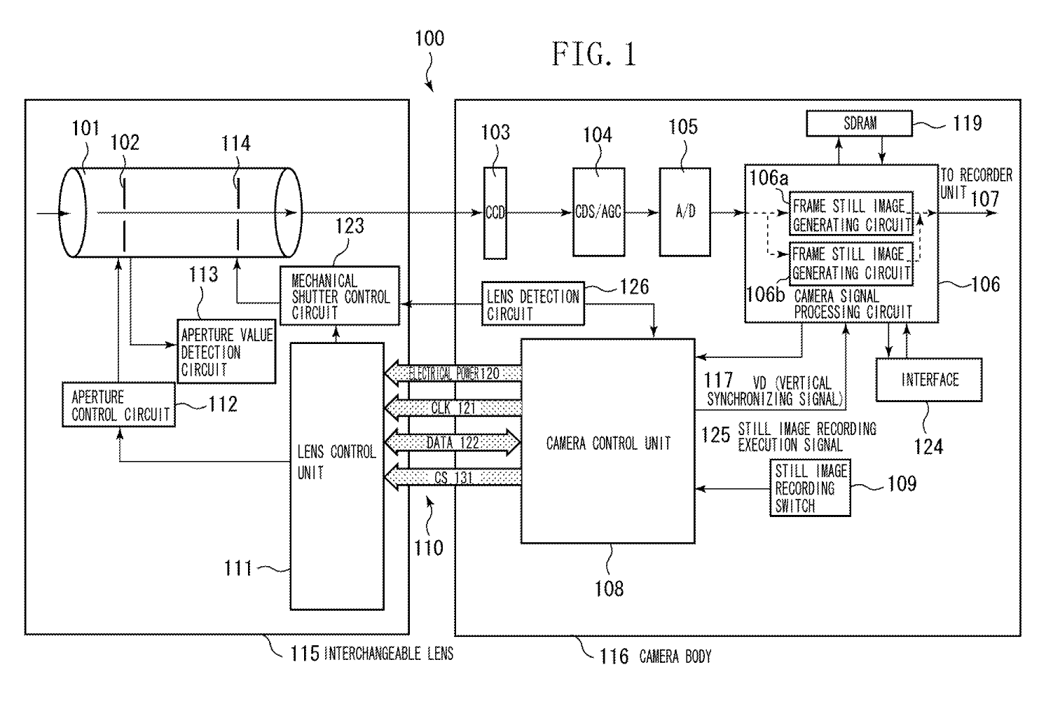

FIG. 1 illustrates a configuration of an imaging system 100 according to one exemplary embodiment of the present invention. The imaging system 100 captures an image of a subject imaged via an interchangeable lens 115.

For discussion purposes, the imaging system 100 is in a digital video camera that can capture the moving images and the still images. However, it is noted the imaging system 100 is not limited to a video camera, and may another type of imaging system.

The imaging system 100, as illustrated in FIG. 1, includes an interchangeable lens 115, and a camera body 116 on which the interchangeable lens 115 can be detachably mounted.

The interchangeable lens 115 includes an imaging (image capturing) lens 101, an iris 102 for adjusting the amount of light, and an aperture control circuit 112 for controlling the iris 102. Further, the interchangeable lens 115 includes an aperture value detection circuit 113 for detecting an aperture value of the iris 102, and a mechanical shutter 114 for inhibiting an exposure by interrupting the amount of light incident on the CCD 103. Furthermore, the interchangeable lens 115 includes a mechanical shutter control unit 123 for operating the mechanical shutter 114 at a high speed, and a lens control unit 111 for controlling the interchangeable lens 115.

A camera body 116 includes the CCD 103 serving as an image sensor and a correlated double sampling circuit/automatic gain control circuit (CDS/AGC) 104. Further, the camera body 116 includes an analog-to-digital (A/D) converter 105 for converting an analog video signal into a digital signal, a camera signal processing circuit 106, and a signal path 107 leading to a recorder unit. Further, the camera body 116 includes a synchronous dynamic random access memory (SDRAM) 119 for temporarily storing video signals on which the video signal processing has been performed in the camera signal processing circuit 106. Furthermore, the camera body 116 includes a path for transmitting a vertical synchronizing signal (VD) 117 generated in the camera signal processing circuit 106. Still image data stored on the SDRAM 119 are recorded in a storage medium (not illustrated) via an interface 124. Further, the camera body 116 includes a camera control unit 108 for controlling the inside of the camera body 116, communication lines 110 for communicating various information between the camera control unit 108 and the lens control unit 111, and a still image recording switch 109 for recording still images.

Further, the camera body 116 includes a path for transmitting a still image recording execution signal 125 used to generate a still image inside the camera signal processing circuit 106 when the user captures a still image using the still image recording switch 109. Further, the camera body 116 includes an interface 124 for recording a still image captured by the still image recording switch 109 in the storage medium (not illustrated), and a lens detection circuit 126 for detecting whether the interchangeable lens 115 is mounted on the camera body 116. A signal 107 from the camera signal processing circuit 106 is output to a recorder unit (not illustrated). Further, the communication lines 110 include a power supply line 120, a clock (CLK) line 121, a data (DATA) line 122, and a chip select signal (CS) line 131.

An example operation of the imaging system 100 is described next. Power is supplied from the camera body 116 to the interchangeable lens 115 through the power supply line 120 when the interchangeable lens 115 is mounted on the camera body 116. An optical image of the subject passes through the imaging lens 101. The light amount of the optical image is controlled by the iris 102, and the image is formed on the CCD 103. The image is photo-electrically converted into video signals in the CCD 103. In the CDS/AGC circuit 104, noise elimination and gain control are performed on the video signals. After that, the A/D converter 105 converts the video signals to digital signals which is transmitted to the camera signal processing circuit 106. The camera signal processing circuit 106 processes the digital video signals to generate standardized video signals. These video signals are transmitted to the recorder unit 107 as digital signals, and are recorded in a storage medium (not illustrated).

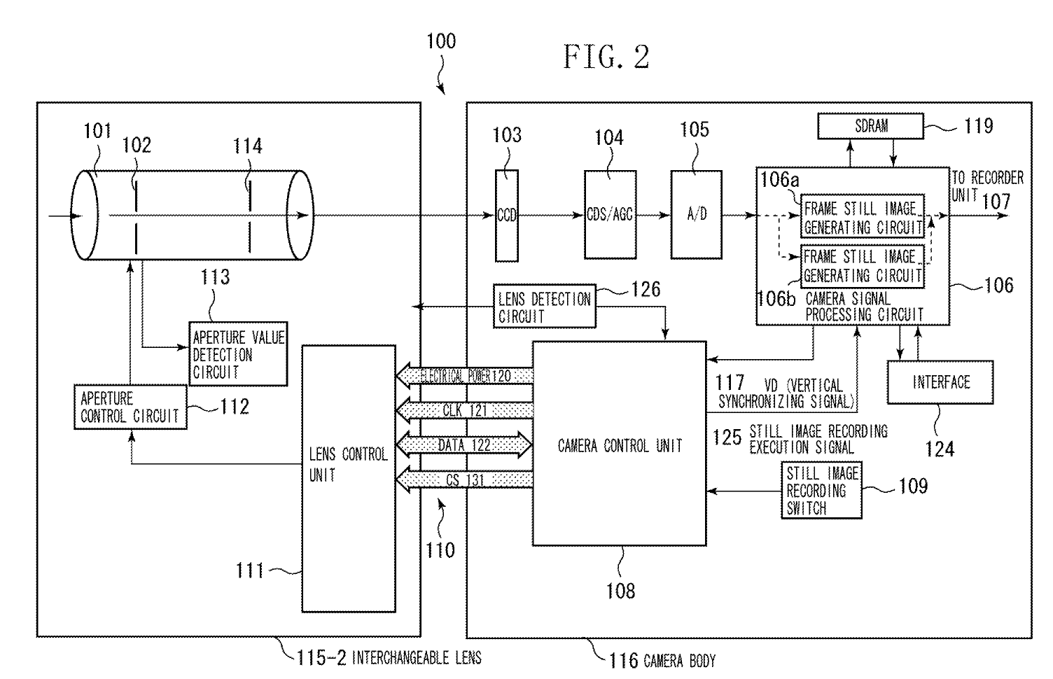

FIG. 2 illustrates a configuration of the imaging system 100 including the camera body 116 and an interchangeable lens 115-2 on which the mechanical shutter 114 is not mounted. In contrast to FIG. 1, the mechanical shutter 114 and the mechanical shutter control circuit 123 are not mounted in FIG. 2. In such a system, a status data signifying that the mechanical shutter 114 is not mounted is transmitted from the lens control unit 111 to the camera control unit 108 using a communication path 110.

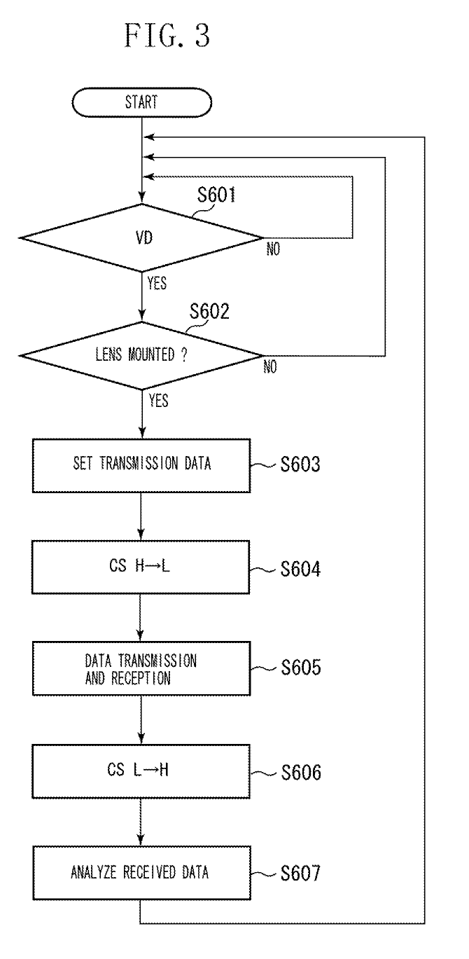

Next, the communication process for determining whether the mechanical shutter 114 is mounted on the interchangeable lens 115 is described with reference to FIG. 3. The communication is performed between the camera control unit 108 and the lens control unit 111

Referring to FIG. 3, at first, the camera control unit 108 determines whether a VD 117 output from the camera signal processing circuit 106 is input, in step S601. When the VD 117 is input to the camera control unit 108 (YES in step S601), the camera control unit 108 determines whether the interchangeable lens 115 is mounted on the camera body 116, in step S602. If the interchangeable lens 115 is not mounted on the camera body 116 (NO in step S602), the process returns to step S601. On the other hand, if the interchangeable lens 115 is mounted on the camera body 116 (YES in step S602), transmission data is set in step S603.

After that, a polarity of the CS line 131 is set from H to L in step S604, and data transmission and reception are performed in step S605. After the data transmission and reception are completed, the polarity of CS line 131 is set from L to H in step S606. Then, in step S607, the data received from the lens control unit 111 is analyzed.

Such a flow (each step) is carried out in a pre-determined format between the camera control unit 108 and the lens control unit 111. Communication is possible when this format is strictly kept by both the interchangeable lens 115 and the camera body 116.

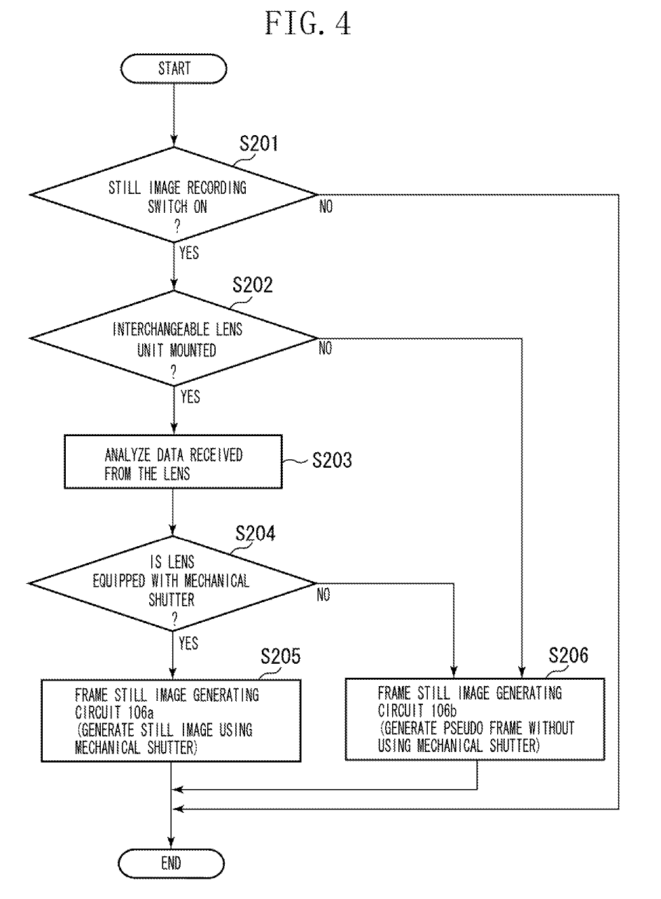

Next, an operation of the camera body 116 (the camera control unit 108) is described with reference to the flow chart of FIG. 4. The camera control unit 108 determines whether a still image recording switch 109 is ON in step S201. If the still image recording switch 109 is not ON (NO in step S201), the still image capturing is not performed, and the process ends.

If the still image recording switch 109 is ON (YES in step S201), the process advances to step S202. In step S202, the lens detection circuit 126 determines whether the interchangeable lens 115 is mounted on the camera body 116. If the interchangeable lens 115 is not mounted on the camera body 116 (NO in step S202), the process advances to step S206. In step S206, a still image is generated in a frame still image generating circuit 106b. A method for generating the still image in the frame still image generating circuit 106b will be described later.

On the other hand, if it is determined that the interchangeable lens 115 is mounted on the camera body 116 (YES in step S202), the process proceeds to step S203. In step S203, the camera control unit 108 analyzes whether the mechanical shutter 114 is mounted based on the data received from the lens control unit 111. If the mechanical shutter 114 is not mounted (NO in step S204), the process proceeds to step S206. In step S206, a still image is generated in the frame still image generating circuit 106b.

A method for generating the still image in the frame still image generating circuit 106b will be described below. If the mechanical shutter 114 is mounted (YES in step S204), the process proceeds to step S205. In step S205, a still image is generated in the frame still image generating circuit 106a. A method for generating a still image in the frame still image generating circuit 106a will be described below.

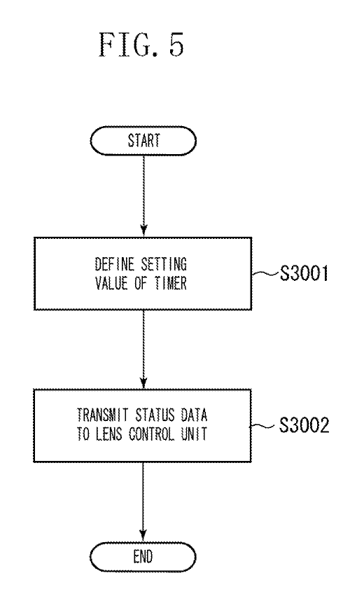

Next, with reference to FIGS. 5 to 9, it is described that the frame still image generating circuit 106a generates a still image using the mechanical shutter 114.

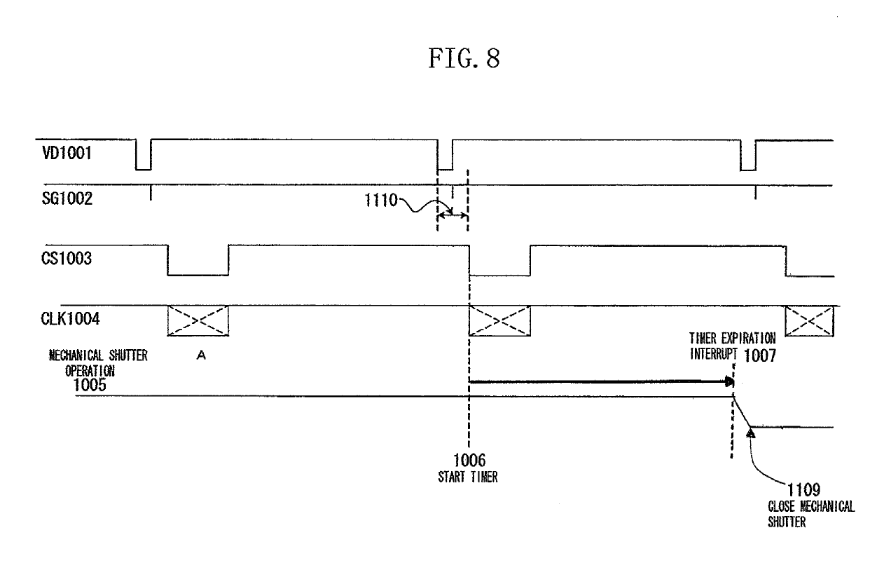

Referring to FIG. 5, in step S3001, a setting value of a timer of the camera control unit 108 is defined at the moment that the still image recording switch 109 is ON. Further, what the timer indicates will be described below with reference to FIG. 8. Then, in step S3002, status data signifying ON of the still image recording switch 109, and the setting value of the timer defined in step S3001, are transmitted to the lens control unit 111.

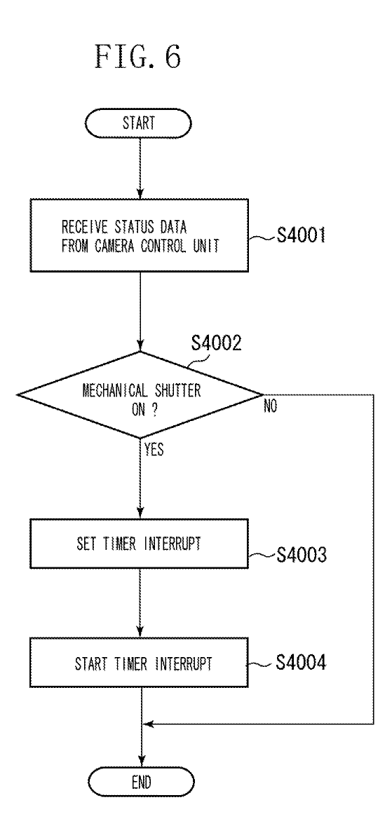

Referring to FIG. 6, in the interchangeable lens 115, at first, the lens control unit 111 receives the data transmitted from the camera control unit 108 (status data) in step S4001. Next, the lens control unit 111 determines whether a request for closing the mechanical shutter 114 (ON) has arrived based on the received status data in step S4002. If no request to close the mechanical shutter 114 has arrived (NO in step S4002), the process ends. If a request to close the mechanical shutter 114 has arrived (YES in step S4002), the process proceeds to step S4003. In step S4003, the lens control unit 111 decodes the timer setting value based on the received status data in step S4001, and a timer interrupt setting is defined.

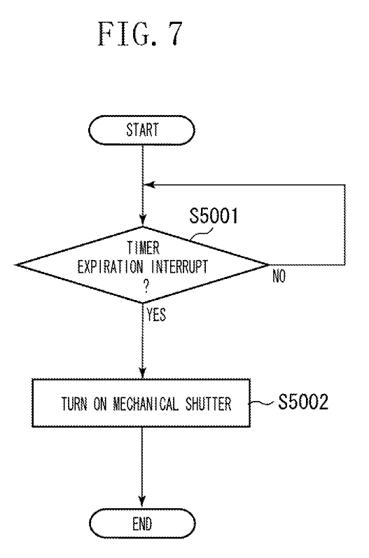

Then, the lens control unit 111 starts a timer interrupt at a pre-determined timing in step S4004. The pre-determined timing will be described below with reference to FIG. 8. Further, as illustrated in FIG. 7, the lens control unit 111 generates a control signal for closing the mechanical shutter 114 in step S5002, after a timer expiration interrupt defined in step S4003 of FIG. 6 occurs in step S5001.

FIG. 8 is a timing chart illustrating a series of flows from step S4001 to S4004, and from step S5001 to S5002, in a time series fashion.

Referring to FIG. 8, reference numeral VD 1001 denotes a VD 117 output from the camera signal processing circuit 106. A signal SG 1002 (hereinafter, referred to as SG signal) transfers electric charges from the CCD 103 to a vertical transcribing gate. A signal CS 1003 is output from the camera control unit 108 to the lens control unit 111 at timing approximately synchronizing with a fall phase of the VD 1001. The CS 1003 is output approximately in synchronization with the VD 1001 output from the camera body 116 for each VD. In other words, the camera control unit 108 and the lens control unit 111 communicate with each other for each VD. A clock (CLK) signal CLK 1004 is required for performing clock synchronous type communication from the camera control unit 108 to the lens control unit 111.

Now, an operation 1005 of the mechanical shutter 114 will be described. It is assumed that status data signifying a request for closing the mechanical shutter 114 and the timer setting value are included in the signal received at the timing indicated by A in FIG. 8.

Now referring to FIG. 8, a timer starts from a timer start timing 1006 which is synchronous with a fall of the CS 1003. The fall of the signal CS 1003 synchronizes with the next fall of the signal VD 1001. At timing that the timer expires, the timer expiration interrupt (timer expiration interrupt timing 1007) occurs. The mechanical shutter 114 is operated by closing the mechanical shutter 114 at a high speed via the mechanical shutter control circuit 123 at this timing.

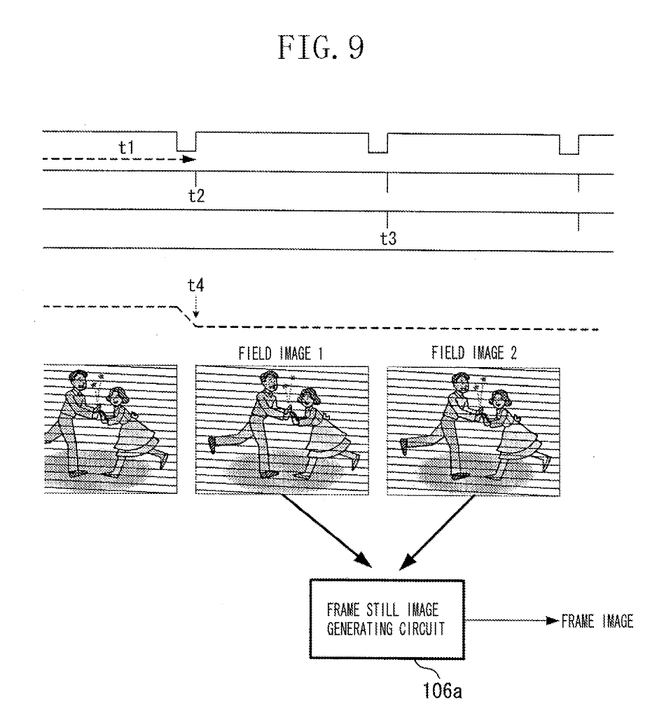

Referring to FIG. 9, in order to generate a still image from video signals obtained by light exposure at timing t1, the mechanical shutter 114 is shielded from light at timing t4. The light shield is performed at timing t4, therefore, a video signal read at timing t2 is a field image 1, and a video signal read at timing t3 is a field image 2. The field image 1 and field image 2 have no time difference because they are the video signals obtained by light exposure at timing t1. Therefore, a high-quality still image without blur can be generated from a frame image using the field image 1 and field image 2 that have no time difference.

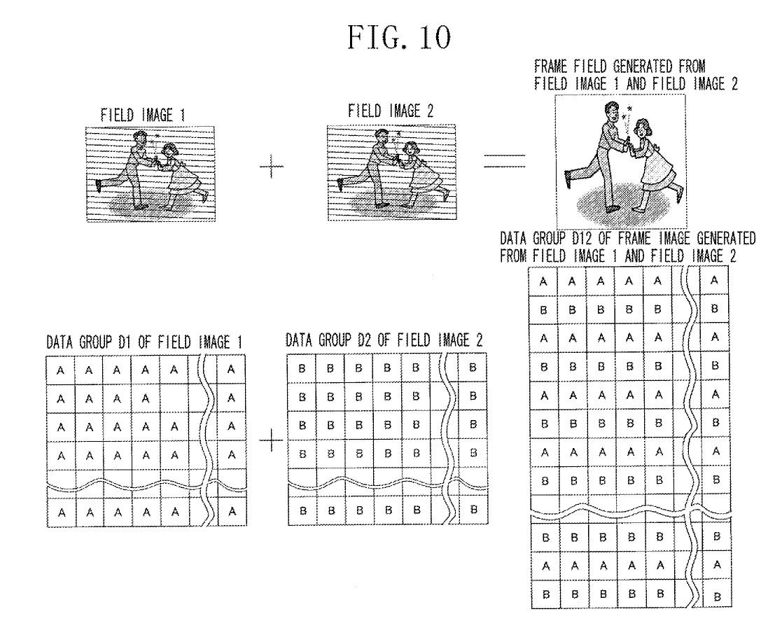

More specifically, referring to FIG. 10, when the signals for the field image 1 are the A's, a data group generated on the SDRAM 119 is D1. Likewise, when the signals for the field image 2 are the B's, a data group generated on the SDRAM 119 is D2. Based on these data groups D1 and D2, data groups D12 of the illustrated frame image is generated. Thus, the case where the frame still image generating circuit 106a generates a still image has been described in detail.

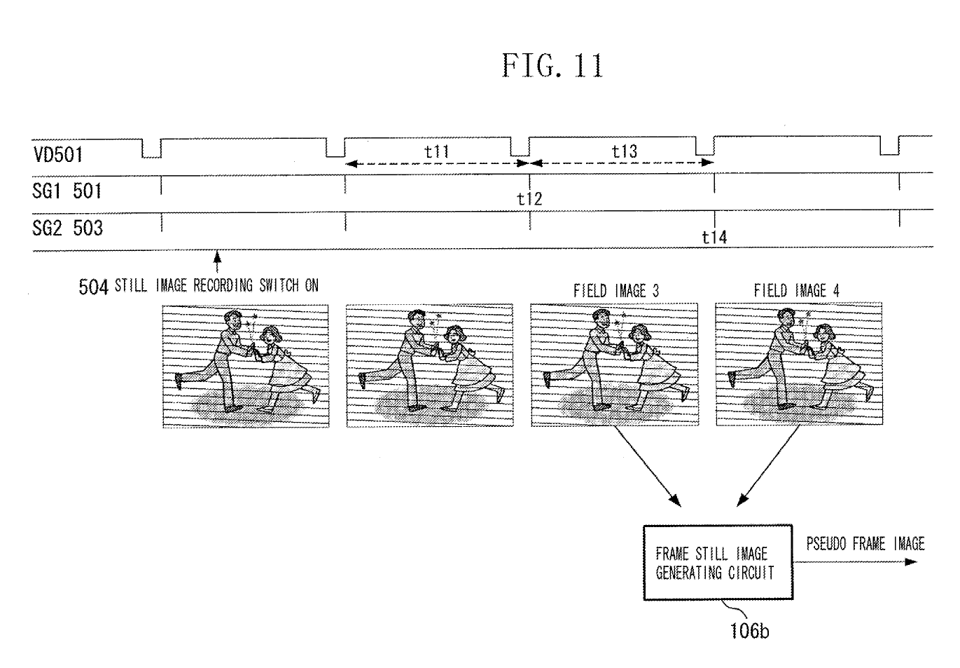

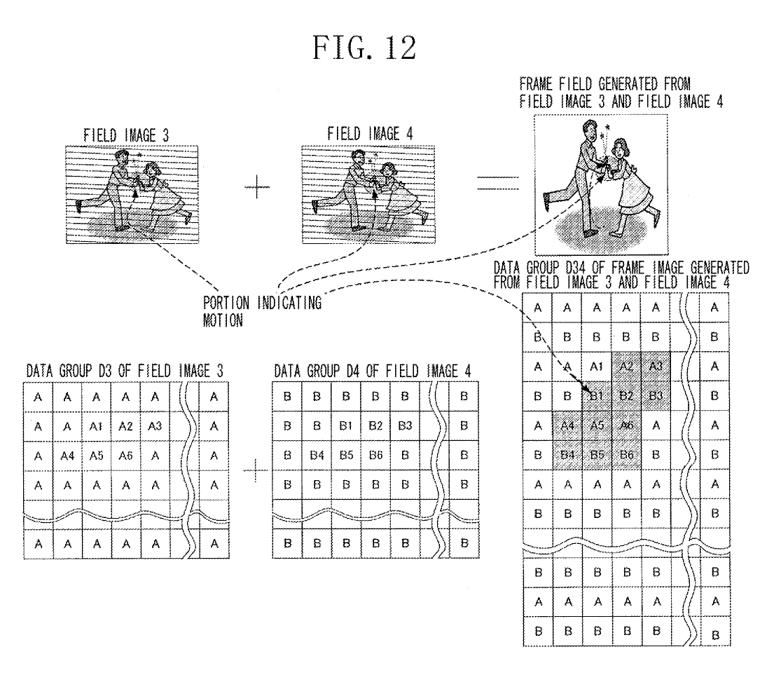

Next, the case where the frame still image generating circuit 106b generates a still image will be described. Referring to FIG. 11, a video signal obtained by light exposure at timing t11 is read from the CCD 103 at timing t12, and a field image 3 is generated. Likewise, a video signal obtained by light exposure at timing t13 is read from the CCD 103 at timing t14, and a field image 4 is generated. In the frame still image generating circuit 106b, a frame image is formed using the field image 3 and the field image 4. Referring to FIG. 12, D3 denotes a data group of the field image 3. D4 denotes a data group of the field image 4. D34 denotes a data group of the frame image.

As can be seen from FIG. 11, the field image 3 and the field image 4 are not the video signals obtained by exposure at the same time, and there are time difference between the field image 3 and the field image 4. If the subject shows motion caused by the time difference, a blur occurs at the portion indicating motion, and a quality of the still image is lost. For example, in a part indicated as “portion indicating motion” within the drawing of FIG. 12, if two images of the field images 3 and 4 are used to generate a frame image, blurring occurs at the portion indicating motion, and the still image quality is lost.

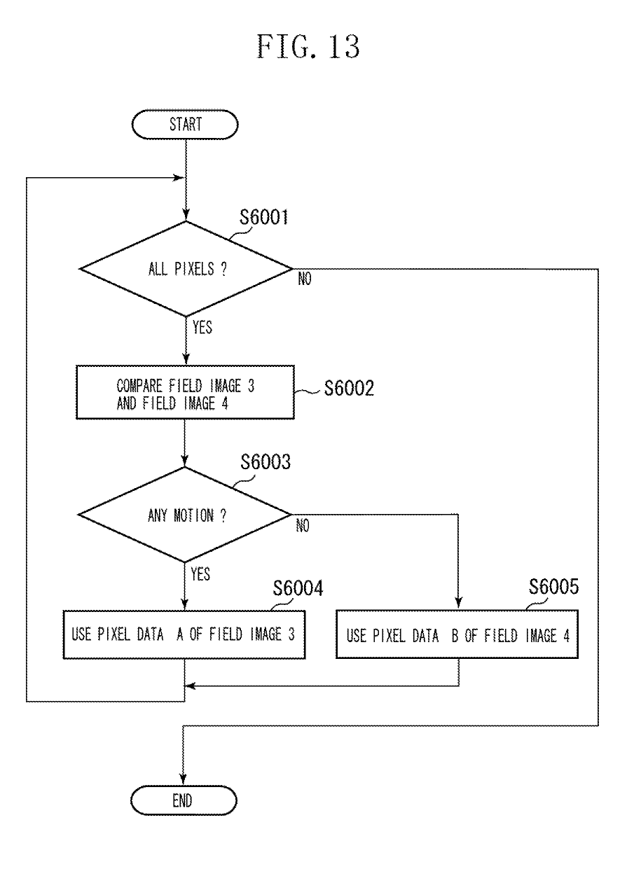

Next, a process for improving a blurred portion is described using the flow chart of FIG. 13. In step S6001, the camera control unit 108 compares all pixels of the two field images 3 and 4 and determines whether an interpolation operation is finished. If the interpolation operation for all pixels is finished (YES in step S6001), a frame image generating process ends. On the other hand, if the interpolation operation for all pixels is not finished (NO in step S6001), the interpolation operation continues. Then, in step S6002, the camera control unit 108 compares the field image 3 and field image 4.

More specifically, the comparison of the field images are made pixel-by-pixel. For example, in regard to pixels A1 to A6 of the field image 3, and pixels B1 to B6 of the field image 4, the comparisons are made as follows: A1 is compared with B1, A2 with B2, A3 with B3, A4 with B4, A5 with B5, and A6 with B6, and it is checked whether any motion can be detected in these pixels, in step S6003. If no motion is detected (NO in step S6003), the camera control unit 108 uses the pixel data B of the field image 4 as it is, in the still image in step S6005. However, if motion is detected (YES in step S6003), the camera control unit 108 uses the pixel data A of the field image 3 as the still image in step S6004. Thus, the interpolation of the frame image is carried out, and a quasi image thus formed is called a pseudo frame image.

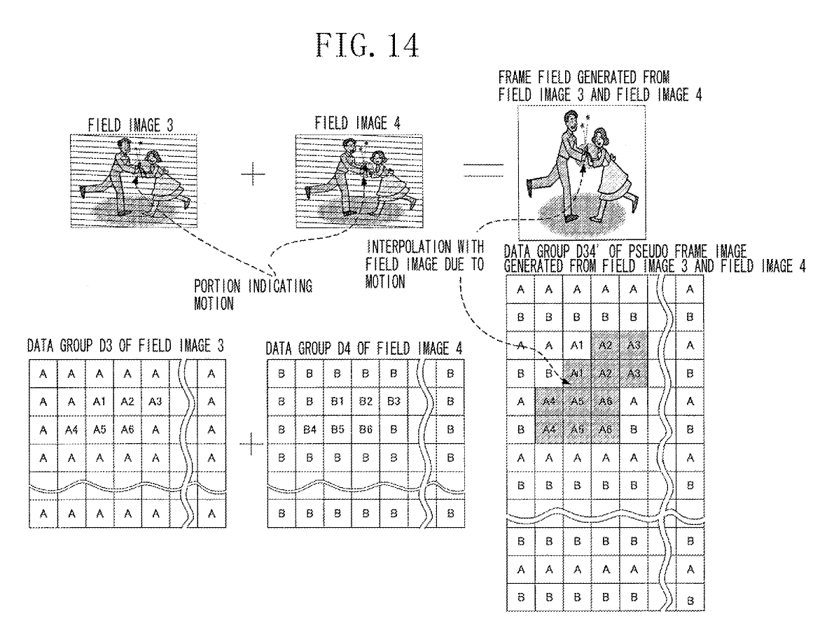

FIG. 14 specifically illustrates the pseudo frame image. Portions indicated in gray in FIG. 14 are the interpolated signals. Namely, pixel B1 is replaced with A1, B2 with A2, B3 with A3, B4 with A4, B5 with A5, and B6 with A6. D34′ are a data group of the pseudo frame image.

According to the exemplary embodiment described above, it is determined on the camera body 116 side whether the mechanical shutter 114 is mounted on the interchangeable lens 115 side. Based on the determination result, a method for generating and processing a still image on the camera body 116 side is switched. More specifically, an image forming process is switched in a following case: A super-telephoto lens, an ultra wide lens, and a macro lens are already in the market. The mechanical shutter 114 may not be mounted on these lens unit having various features. In such a case, an image forming process is switched to the still image generating method by which one frame image is quasi-formed from two fields information. In this way, a high quality still image can be captured.

In more detail, if the conventional interchangeable lens equipped with the mechanical shutter is mounted on a camera body, a high-quality still image can be captured as before. However, if an interchangeable lens that is not equipped with the mechanical shutter is mounted, the still image generating method is switched (i.e., switched from the frame still image generating circuit 106a to the frame still image generating circuit 106b). In this way, a comparatively high-quality still image can be captured practically without any problems.

### Other Exemplary Embodiments

Moreover, each exemplary embodiment can be achieved by various other methods. For example, the storage medium that stores the program code or software that achieves the functions of the above exemplary embodiment can be supplied to the system or apparatus, and a computer (central processing unit (CPU) or micro processing unit (MPU)) of the system or the apparatus can read the program code stored in the storage media and execute the program code. In this case, the program codes read from the storage medium achieves the functions of the above exemplary embodiments and the storage medium that stores the program codes constitutes the present invention. Further, not only the functions of the exemplary embodiments described above are achieved by executing the program codes read by the computer but also the operating system (OS) that is running on the computer performs a part or all of the actual processing based on the instruction of the program codes and implements the functions of the above exemplary embodiments.

Further, the following case is also included in the present invention. The program codes read from the storage medium are written into a memory that is provided at a function extension unit connected to the computer or a function extension card inserted in the computer. After that, based on the instruction of the program codes described above, the CPU provided at the functional extension unit or the function extension card described above does a part or all of the actual processing. The functions of the exemplary embodiments described above are also achieved by this processing.

When the present invention is applied to the storage medium, the storage medium stores the program codes corresponding to the previously described procedures.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-297342 filed Nov. 1, 2006, which is hereby incorporated by reference herein in its entirety.

What is claimed is:

1. An imaging apparatus, comprising:
an imaging unit;
a first image generating unit configured to generate a still image having one frame, based on two field images obtained by light exposure at the same timing;
a second image generating unit configured to generate a still image having one frame, based on two field images obtained by light exposure at different timings; and
a switching unit configured to switch to either one of the first image generating unit and the second image generating unit, depending on whether a detachably mounted lens apparatus includes a shutter unit that interrupts an exposure of the imaging unit.

2. The imaging apparatus according to claim 1, wherein the image generating unit is switched to the second image generating unit if the detachably mounted lens apparatus has the shutter unit.

3. The imaging apparatus according to claim 2, wherein the second image generating unit generates a still image by detecting a portion indicating motion based on a difference in the two field images, such that one field image is used for a portion indicating motion, and another field image is used for a portion indicating no motion.

4. The imaging apparatus according to claim 3, wherein the portion indicating motion is detected pixel by pixel.

5. A method of controlling an imaging apparatus having an imaging unit, the method comprising:
a first image generating step of generating a still image having one frame based on two field images obtained by light exposure at the same timing;
a second image generating step of generating a still image having one frame based on two fields of image obtained by light exposure at different timing; and
switching to either one of the first image generating step and the second image generating step, depending on whether a detachably mounted lens apparatus includes a shutter unit that interrupts an exposure of the imaging unit.

6. A computer readable storage medium containing computer-executable instructions for a program for controlling an imaging apparatus having an imaging unit, the medium comprising:
computer-executable instructions for a first image generating step of generating a still image having one frame based on two field images obtained by light exposure at the same timing;
computer-executable instructions for a second image generating step of generating a still image having one frame based on two fields of image obtained by light exposure at different timing; and
computer-executable instructions for switching to either one of the first image generating step and the second image generating step, depending on whether a detachably mounted lens apparatus includes a shutter unit that interrupts an exposure of the imaging unit.
